(19) United States
(12) Patent Application Publication
(10) Pub. No.: US 2021/0195717 A1
(43) Pub. Date: Jun. 24, 2021

(54) INTELLIGENT AUXILIARY LIGHTING SYSTEM, METHOD, AND MOVABLE PLATFORM

(71) Applicant: SZ DJI TECHNOLOGY CO., LTD., Shenzhen (CN)

(72) Inventors: Jiebin XIE, Shenzhen (CN); Wei REN, Shenzhen (CN); Xiaoming WANG, Shenzhen (CN)

(73) Assignee: SZ DJI TECHNOLOGY CO., LTD., Shenzhen (CN)

(21) Appl. No.: 17/190,432

(22) Filed: Mar. 3, 2021

Related U.S. Application Data
(63) Continuation of application No. PCT/CN2019/107490, filed on Sep. 24, 2019.

(51) Int. Cl. H05B 47/125; G06K 9/46

(52) U.S. Cl. CPC H05B 47/125; B64C 39/024; G06K 9/4661

(57) ABSTRACT

The present disclosure relates to an intelligent auxiliary lighting system for a movable platform. The intelligent auxiliary lighting system may include a distance measuring device for obtaining distance information of objects in a surrounding environment where the movable platform is located and an auxiliary lighting system. The auxiliary lighting system may include a light source and a light source control device. The light source control device may be configured to control turning on the light source based on the distance information and/or control brightness of the light source based on the distance information.

### CROSS-REFERENCE TO RELATED APPLICATION

The present application is a continuation of International Application No. PCT/CN2019/107490, filed on Sep. 24, 2019, the entire contents of which being incorporated herein by reference in its entirety.

### TECHNICAL FIELD

The present disclosure relates to lighting technology, in particular, to an intelligent auxiliary lighting system, method, and a movable platform.

### BACKGROUND

The problem of unmanned aerial vehicles (UAV) flying at night has attracted widespread attention. The existing technology can only provide a single lighting solution on the UAV. For example, the user can control the lighting equipment on the UAV to turn on and off through physical buttons on a remote control. Furthermore, brightness of the lighting equipment cannot be flexibly adjusted automatically.

### SUMMARY

In accordance with the disclosure, there is provided an intelligent auxiliary lighting system for a movable platform. The intelligent auxiliary lighting system may include a distance measuring device for obtaining distance information of objects in a surrounding environment where the movable platform is located and an auxiliary lighting system. The auxiliary lighting system may include a light source and a light source control device. The light source control device may be configured to control turning on the light source based on the distance information and/or control brightness of the light source based on the distance information.

Also in accordance with the disclosure, there is provided an intelligent auxiliary lighting method for a movable platform. The movable platform may include a distance measuring device, a light source, and a light source control device. The method may include acquiring distance information of objects in a surrounding environment where the movable platform is located by the distance measuring device; and controlling turning on the light source based on the distance information and/or controlling brightness of the light source based on the distance information by the light source control device.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a block diagram of an intelligent auxiliary lighting system according to an exemplary embodiment of the present disclosure;

FIG. 2 shows a graph of light intensity versus distance;

FIG. 3 shows a flowchart of an intelligent auxiliary lighting method according to an exemplary embodiment of the present disclosure;

FIG. 4 shows a block diagram of a light source control device according to an exemplary embodiment of the present disclosure; and

FIG. 5 shows a block diagram of a movable platform according to an exemplary embodiment of the present disclosure.

### DETAILED DESCRIPTION

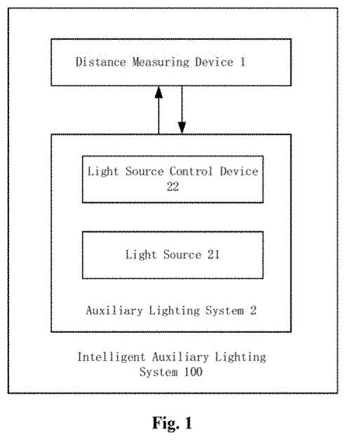

The specific embodiments of the present disclosure are further described in detail below with reference to the drawings and embodiments. The following examples are intended to illustrate the disclosure but are not intended to limit the scope of the disclosure. It should be noted that, in the case of no conflict, the features in the embodiments and the embodiments in the present application could be arbitrarily combined with each other. Throughout the description of the disclosure, reference is made to FIGS. 1-5. When referring to the figures, like structures and elements shown throughout are indicated with like reference numerals. It should be understood that the dimensions of the various parts shown in the drawings are not drawn in the actual scale. Based on these embodiments of the present disclosure, all other embodiments obtained by those of ordinary skill in the art without creative work shall fall within the protection scope of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

Unless otherwise defined, all technical and scientific terms used herein have the same meaning as commonly understood by those of ordinary skill in the technical field of the present disclosure. The terms used in the specification of the present disclosure herein are only for the purpose of describing specific embodiments, and are not intended to limit the present disclosure.

In addition, the term “connected” or “coupled” herein includes any direct or indirect means of connection. Therefore, if it is described that a first device is connected or coupled to a second device, it means that the first device can be directly connected or coupled to the second device, or indirectly connected or coupled to the second device through other devices.

The term “and/or” used in this specification describes only an association relationship of the associated objects, which indicates that there can be three relationships. For example, the term “A1 and/or B1” may indicate three scenarios, that is, A1 existing alone, A1 and B1 existing simultaneously, and B1 existing alone. In addition, the character “/” in this text generally indicates that the associated objects before and after are in an “or” relationship.

In the description of the specification, references made to the term “one embodiment,” “some embodiments,” and “exemplary embodiments,” “example,” and “specific example,” or “some examples” and the like are intended to refer that specific features and structures, materials or characteristics described in connection with the embodiment or example that are included in at least some embodiments or example of the present disclosure. The schematic expression of the terms does not necessarily refer to the same embodiment or example. Moreover, the specific features, structures, materials or characteristics described may be included in any suitable manner in any one or more embodiments or examples.

The problem of unmanned aerial vehicles (UAV) flying at night has attracted widespread attention. Due to dim brightness of the transmitted image, the operator of the UAV may not ascertain obstacles in front. In addition, performance of the UAV's binocular vision sensor is generally poor in dark environment. By adding an intelligent auxiliary lighting system, the operator can clearly see the obstacles in front of the UAV, and at the same time improve the performance of the binocular vision sensor at night, thereby improving the safety of the UAV.

Some embodiments of the present disclosure propose an intelligent auxiliary lighting system, method, device and a movable platform, which utilize a distance measuring device to obtain distance information of objects in the surrounding environment where the movable platform is located, and control the light source based on the obtained distance information. It should be noted that the intelligent auxiliary lighting system, method, and device of some embodiments of the present disclosure are not limited to be applied to movable platforms such as unmanned aerial vehicles, and can also be applied to other unmanned mobile carriers such as unmanned vehicles, handheld camera devices and robots, and even non-mobile carriers, such as intelligent traffic monitoring systems in dark light or night conditions, for example, for photographing traffic violation etc., or non-mobile carriers such as security monitoring systems.

Some embodiments of the present disclosure provide an intelligent auxiliary lighting system, method, device, and movable platform. The intelligent auxiliary lighting system is disposed on the movable platform. The intelligent auxiliary lighting system may include a distance measuring device for obtaining distance information of objects in the surrounding environment where the movable platform is located. The intelligent auxiliary lighting system may further include an auxiliary lighting system. The auxiliary lighting system may include a light source for providing lighting and a light source control device for controlling the turning on or off of the light source based on the distance information and/or controlling the brightness of the light source based on the distance information.

Some embodiments of the present disclosure combine the distance measuring device and the auxiliary lighting system to improve the safety of the movable platform in the dark environment. At the same time, the distance information obtained by the distance measuring device may be used to control the light source, which can reduce energy loss, improve lighting efficiency, and avoid overexposure.

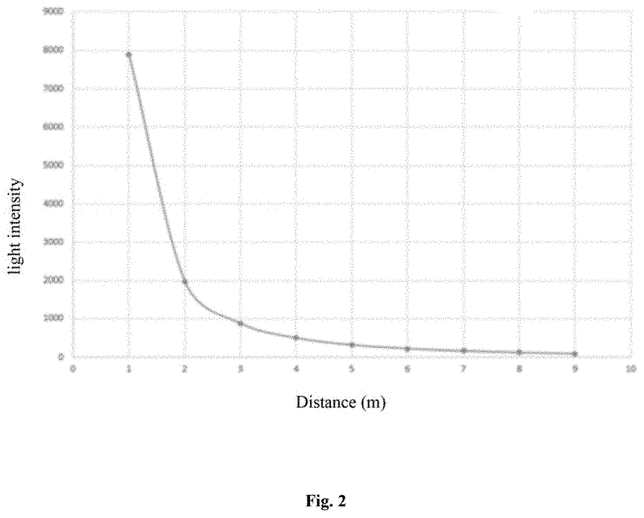

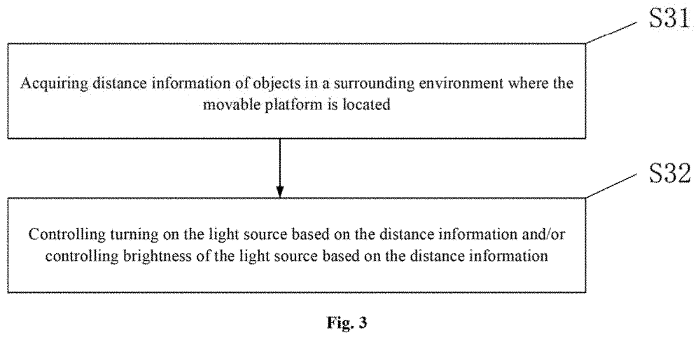

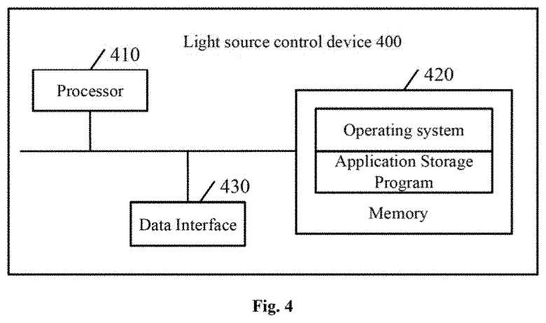

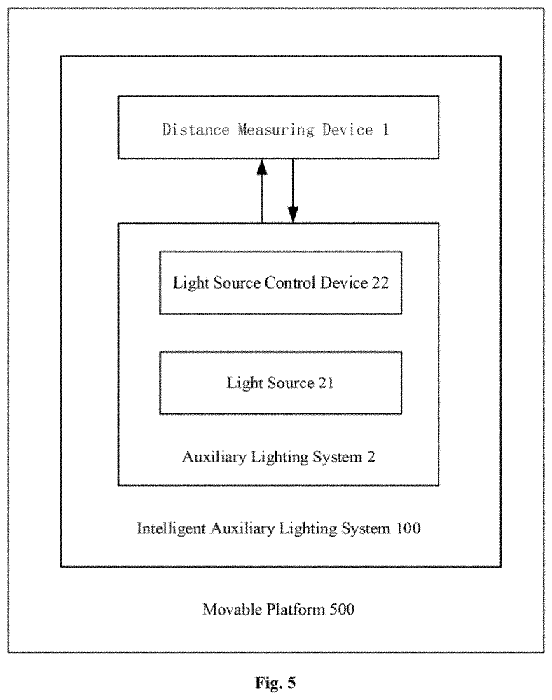

The intelligent auxiliary lighting system, method, device and movable platform according to some embodiments of the present disclosure will be described in detail below in conjunction with FIGS. 1-5. FIG. 1 shows a block diagram of an intelligent auxiliary lighting system according to an exemplary embodiment of the present disclosure. FIG. 2 shows a graph of light intensity varying with distance. FIG. 3 shows a flowchart of an intelligent auxiliary lighting method according to an exemplary embodiment of the present disclosure. FIG. 4 shows a block diagram of a light source control device according to an exemplary embodiment of the present disclosure. FIG. 5 shows a block diagram of a movable platform according to an exemplary embodiment of the present disclosure.

FIG. 1 shows a block diagram of an intelligent auxiliary lighting system according to an exemplary embodiment of the present disclosure. The intelligent auxiliary lighting system is disposed on a movable platform (not shown). However, the present disclosure is not limited to this, and the intelligent auxiliary lighting system can also be disposed on a non-mobile platform/carrier. As shown in FIG. 1, the intelligent auxiliary lighting system 100 may include a distance measuring device 1 for obtaining distance information of objects in the surrounding environment where the movable platform is located and an auxiliary lighting system 2. The auxiliary lighting system 2 may include a light source 21 for providing lighting and a light source control device 22. When the intelligent auxiliary lighting system is applied to a mobile platform/carrier, the lighting direction may be the moving direction of the moving carrier. When the intelligent auxiliary lighting system is applied to a non-moving carrier, the lighting direction may be the direction that needs to be monitored. But the present disclosure is not limited to these scenarios, and it can be any other direction that needs lighting. The light source control device 22 may be used for controlling the turning on or off of the light source 21 based on the distance information and/or controlling the brightness of the light source 21 based on the distance information. Furthermore, the distance measuring device may be connected to the auxiliary lighting system and they communicate with each other through some means such as a serial port. The intelligent auxiliary lighting system of some embodiments of the present disclosure combines the distance measuring device and the auxiliary lighting system to improve the safety of the movable platform in the dark environment. At the same time, the distance information obtained by the distance measuring device may be utilized to reduce energy loss, improve lighting efficiency, and avoid overexposure.

The distance measuring device may be a binocular vision sensor, a time of flight (TOF) sensor, a lidar, a millimeter wave radar, an ultrasonic radar or an infrared sensor, etc. Among them, the binocular vision sensor is based on parallax principle and uses an imaging equipment to obtain two images of the measured object from different positions, and calculates positional deviation between corresponding points of the images to obtain three-dimensional geometric information of the object. The binocular vision sensor contains at least two camera modules as well as chips for image processing and depth calculation. The modules are used to calculate the distance of the object in front. The TOF sensor continuously sends light pulses to the object, and then uses the sensor to receive the light pulses returned from the object. The TOF sensor obtains the distance of the object by detecting flight time of the light pulse.

According to an exemplary embodiment of the present disclosure, controlling the light source based on the distance information includes controlling the light source to be turned on based on the distance information.

According to an exemplary embodiment of the present disclosure, controlling the turning on of the light source based on the distance information includes turning on the light source when the distance information satisfies a preset condition. The preset condition may include that the shortest distance in the distance information is less than a predetermined distance threshold. That is, when the shortest distance in the detected distance information of the distance measuring device is less than the predetermined distance threshold, the light source is turned on. For example, when the distance measuring device detects that the distance of the nearest obstacle in the surrounding environment is less than a certain distance threshold, the light source is turned on.

According to an exemplary embodiment of the present disclosure, the predetermined distance threshold is set based on a speed of the movable platform. Optionally, the predetermined distance threshold is directly proportional to the speed of the movable platform, and the greater the speed of the movable platform, the greater the predetermined distance threshold. Optionally, a corresponding reference relationship between the speed of the movable platform and the predetermined distance threshold may be stored in the movable platform. The light source control device may obtain the speed of the movable platform and then determine the distance threshold according to the speed and the corresponding reference relationship. The higher the speed of the movable platform, the longer the braking distance and the greater the risk of collision with obstacles. Therefore, setting the distance threshold to be proportional to the speed of the movable platform may further improve the safety of the movable platform.

According to an exemplary embodiment of the present disclosure, the light source control device is further configured to acquire an image captured by a photographing device on a movable platform; and turn on the light source when average brightness of the image is less than a predetermined brightness threshold.

In this exemplary embodiment, the conditions for turning on the light source here and the aforementioned conditions for turning on the light source are not mutually exclusive. That is, the light source can be turned on when any one of the conditions is met so as to maximize the safety of the movable platform at night. However, the present disclosure is not limited to this. It can also be set to enable the light source only when both conditions are satisfied, that is, the shortest distance in the distance information is less than the predetermined distance threshold and the average brightness of the image is less than the predetermined brightness threshold. As such, operation of the movable platform is safe at night while energy consumption and lighting efficiency of the movable platform are improved.

Optionally, the photographing device may be a depth camera, a visible light camera, an infrared camera, or a thermal imaging camera, etc. When the photographing device is a depth camera, the depth camera and the above-mentioned distance measuring device can be the same device or different devices. For example, the depth camera and the distance measuring device are both binocular vision sensors. Alternatively, the depth camera is a binocular vision sensor, and the distance measuring device is a TOF sensor. It should be noted that those of ordinary skill in the art can make selection of the photographing device and the distance measuring device according to actual needs, which are not limited to those in the above embodiments.

In one embodiment, when the image is an 8-bit grayscale image, the grayscale image can present 256 grayscale levels, and the grayscale level corresponding to the expected brightness of the image is between 100-200. At night, when the exposure time and exposure gain are adjusted to the maximum level, the gray level corresponding to the average brightness is around 50. According to this condition, the auxiliary lighting system can be triggered to turn on. That is, when the image is an 8-bit grayscale image, the predetermined brightness threshold is the corresponding brightness value when the grayscale level is 50. But the present disclosure is not limited to this, and those of ordinary skill in the art can also set other predetermined brightness threshold according to actual needs.

According to an exemplary embodiment of the present disclosure, the light source control device is further used for acquiring an image captured by a camera on a movable platform, and turning on the light source when a target object appears in the image. The target object may include a human face or human body. It can be first determined that whether the target object appears in the image. In one embodiment, the image is segmented into a plurality of image areas, and the features of each image area after segmentation are obtained. Then, it is determined that whether the target object appears in the image based on the features. The features here may include but are not limited to shape features. Optionally, the target object may be a person's limbs or other parts, and the target object may also be a building. In one embodiment of the present disclosure, the light source is turned on when the target object appears in the recognition image. This can save energy consumption and improve lighting efficiency, and at the same time improve the shooting quality at night of the photographing device on the movable platform.

The present auxiliary lighting solutions do not flexibly adjust the brightness of the light source, which may cause a waste of power and a decrease in efficiency in some application scenarios. For example, if the object in front is close, a strong light source is not needed. At this time, the light intensity should be reduced. Especially when there are people in front, too high brightness may cause damage to human vision. At the same time, for a longer lighting distance, higher-power LEDs are usually selected. The conduction current of these LEDs is larger (maybe more than 1 ampere), which may result in higher heat generation. However, the working efficiency of the LED is often affected by the temperature. If the LED is lit for a long time, the LED may cause large heat generation, thereby reducing the efficiency.

Therefore, in order to reduce energy loss, improve lighting efficiency, avoid overexposure and be more user-friendly, the intelligent auxiliary lighting system according to one embodiment of the present disclosure adjusts the brightness of the light source through the light source control device after the light source is turned on.

According to an exemplary embodiment of the present disclosure, controlling the light source based on the distance information includes controlling the brightness of the light source based on the distance information.

According to an exemplary embodiment of the present disclosure, controlling the brightness of the light source based on the distance information includes controlling the brightness of the light source based on the shortest distance in the distance information.

According to an exemplary embodiment of the present disclosure, controlling the brightness of the light source based on the distance information includes controlling the brightness of the light source based on the distance of the target object in the surrounding environment where the movable platform is located.

According to an exemplary embodiment of the present disclosure, controlling the brightness of the light source based on the distance information includes adjusting the brightness of the light source so that the brightness of the object corresponding to the shortest distance in the image or the brightness of the target object in the image is at a predetermined level. Optionally, the image is an image taken by a photographing device on the movable platform. This not only ensures reliable and effective lighting, but also reduces energy loss and improves lighting efficiency.

Optionally, the photographing device may be a depth camera, a visible light camera, an infrared camera, a thermal imaging camera, etc. When the photographing device is a depth camera, the depth camera and the above-mentioned distance measuring device can be the same device or different devices. For example, the depth camera and the distance measuring device are both binocular vision sensors. Alternatively, the depth camera is a binocular vision sensor, and the distance measuring device is a TOF sensor. It should be noted that those of ordinary skill in the art can make selections according to actual needs, which are not limited to those in the above embodiments.

Optionally, when the image is an 8-bit grayscale image, the grayscale image can present 256 grayscale levels, and the grayscale level corresponding to the expected brightness of the image is between 100-200. According to this condition, when the image is an 8-bit grayscale image, the predetermined range is the corresponding brightness value range when the grayscale level is 100-200. However, the present disclosure is not limited to this, and those of ordinary skill in the art can also set other ranges according to actual needs.

According to an exemplary embodiment of the present disclosure, the light source control device is further configured to adjust the lighting direction of the light source based on the orientation information of the object corresponding to the shortest distance or the orientation information of the target object. In other words, the posture of the light source is adjustable. The posture of the light source can be adjusted according to the orientation of the object corresponding to the shortest distance or the orientation of the target object, so that the lighting direction is directed toward the direction of the object corresponding to the shortest distance or the target object. For example, in a scene where a UAV follows a person at night, the light source can always be pointed in the direction of the person. For another example, in a scene where the UAV is surrounding a point of interest, the direction of the light source can always point to the direction of the point of interest. The point of interest can be selected by the user through the user interface.

Optionally, the lighting direction of the light source can be adjusted by adjusting the posture of the movable platform or by adjusting the posture of the light source. For example, when the relative pose of the light source and the UAV is immutable, that is, when the light source is fixedly installed on the UAV, the lighting direction of the light source can be adjusted by adjusting the posture of the UAV. When the light source is installed on the UAV through equipment such as a pan/tilt, the posture of the light source can be adjusted by adjusting the posture of the pan/tilt to adjust the lighting direction of the light source.

Optionally, the number of light sources is multiple, so that the lighting direction of the light source can be adjusted by adjusting the brightness of each of the multiple light sources. For example, the light source array is arranged at equal intervals. When the orientation information of the object corresponding to the shortest distance or target object is acquired, the brightness of each light source can be adjusted to adjust the lighting direction of the light source array.

According to an exemplary embodiment of the present disclosure, controlling the brightness of the light source based on the distance information includes adjusting the conduction current or the duty cycle of the PWM signal to control the brightness of the light source based on the shortest distance in the distance information or the distance of the target object in the surrounding environment where the movable platform is located.

According to an exemplary embodiment of the present disclosure, the conduction current is proportional to the second power of the shortest distance or the second power of the distance to the target object. Alternatively, the conduction current is proportional to a polynomial formed by the second power of the shortest distance or a polynomial formed by the second power of the distance of the target object.

A specific method for controlling the brightness of the light source according to one embodiment of the present disclosure will be described in detail below.

Generally, light-emitting devices such as LEDs can adjust the luminous intensity by controlling the conduction current. The luminous intensity of light-emitting devices such as LEDs is generally directly proportional to the forward conduction current. Another method is to use the PWM signal to adjust the duty cycle to control the brightness of the light. The duty cycle is proportional to the brightness.

In one embodiment, after obtaining the depth map from the depth camera, the light source control device calculates the shortest distance in the depth image, which is recorded as do. As shown in FIG. 2, the light intensity decays with the inverse square of the distance. Assuming that the method of adjusting the current is used to control the brightness, in order to compensate for the decay of the light intensity, the current value can be set to increase with the square of the distance, namely:

I₀=Iᵣ+A*d₀²

Wherein, A is a proportional coefficient, which is selected according to actual situation, and Iᵣ is a reference current, that is, the current when d₀=0.

According to an exemplary embodiment of the present disclosure, adjusting the brightness of the light source by adjusting the conduction current includes setting the conduction current to be proportional to the first, third, or fourth power of the shortest distance, or setting the conduction current to be proportional to a polynomial composed of the first, third, and fourth power of the shortest distance.

According to an exemplary embodiment of the present disclosure, the light source control device is further used to obtain the movement speed of the movable platform and control the brightness of the light source based on the movement speed of the movable platform. Optionally, the greater the speed of the movable platform, the greater the brightness of the light source.

Optionally, the light source control device can control the brightness of the light source based on the distance information of objects in the surrounding environment where the movable platform is located. Optionally, the light source control device can control the brightness of the light source based on the movement speed of the movable platform. Optionally, the light source control device can control the brightness of the light source based on the distance information of objects in the surrounding environment where the movable platform is located and the movement speed of the movable platform.

Optionally, the movable platform stores the corresponding reference relationship between the distance information of objects in the surrounding environment where the movable platform is located and the brightness of the light source. The light source control device can obtain the distance information of the objects in the surrounding environment where the movable platform is located, and determine the brightness of the light source based on the distance information and the corresponding reference relationship. Optionally, the corresponding reference relationship between the speed of the movable platform and the brightness of the light source is stored in the movable platform, and the light source control device can obtain the speed of the movable platform and determine the brightness of the light source based on the speed of the movable platform and the corresponding reference relationship. Optionally, the movable platform stores the corresponding reference relationship between the distance information of objects in the surrounding environment where the movable platform is located and the brightness of the light source and the corresponding reference relationship between the movement speed of the movable platform and the brightness of the light source. The light source control device can obtain the distance information of the objects in the surrounding environment where the movable platform is located and the movement speed of the movable platform, and determine the brightness of the light source based on the distance information and the movement speed and the corresponding reference relationships.

In one embodiment, the higher the speed of the movable platform, the longer the braking distance and the greater the risk of collision with obstacle. Thus, the brightness of the light source can be set to be proportional to the speed of the movable platform. Alternatively, the brightness of the light source can be set to be proportional to the polynomial formed by the shortest distance in the distance information and the speed of the movable platform, which can further improve the safety of the movable platform.

According to an exemplary embodiment of the present disclosure, the light source may be a visible light or infrared light source system.

According to an exemplary embodiment of the present disclosure, the light source includes a light emitting device and a driving circuit, and the light emitting device may be an LED, a laser diode, or a halogen lamp.

According to an exemplary embodiment of the present disclosure, the light source further includes a condenser lens.

According to an exemplary embodiment of the present disclosure, the lighting direction of the light source is the movement direction of the movable platform, and the movable platform may be a UAV, an unmanned vehicle, a handheld camera or a robot, but is not limited to these.

The intelligent auxiliary lighting method according to one embodiment of the present disclosure will be described in detail below with reference to FIG. 3. The method may be applied to a movable platform, and the movable platform includes a light source, and the light source is used to provide lighting. FIG. 3 shows a flowchart of an intelligent auxiliary lighting method according to an exemplary embodiment of the present disclosure. The intelligent auxiliary lighting method may include Step S31 and Step S32.

Step S31 includes obtaining the distance information of objects in the surrounding environmental where the movable platform is located.

The distance measuring device can be a binocular vision sensor, a TOF sensor, a lidar, a millimeter wave radar, an ultrasonic radar or an infrared sensor.

In step S32, the light source is controlled to be turned on based on the distance information and/or the brightness of the light source is controlled based on the distance information.

According to an exemplary embodiment of the present disclosure, controlling the light source based on the distance information includes controlling the light source to be turned on based on the distance information.

According to an exemplary embodiment of the present disclosure, controlling the turning on of the light source based on the distance information includes turning on the light source when the distance information satisfies a preset condition. The preset condition includes that the shortest distance in the distance information is less than a predetermined distance threshold. That is, when the shortest distance in the detected distance information of the distance measuring device is less than the predetermined distance threshold, the light source is turned on. For example, when the distance measuring device detects that the distance of the nearest obstacle in the surrounding environment is less than a certain distance threshold, the light source is turned on.

According to an exemplary embodiment of the present disclosure, the predetermined distance threshold is set according to the speed of the movable platform. Optionally, the distance threshold is directly proportional to the speed of the movable platform, and the greater the speed of the movable platform, the greater the distance threshold. Optionally, a corresponding reference relationship between the speed of the movable platform and the distance threshold is stored in the movable platform. The light source control device can obtain the speed of the movable platform, and then determine the distance threshold according to the speed and the corresponding reference relationship. The higher the speed of the movable platform, the longer the braking distance and the greater the risk of collision with obstacles. Therefore, setting the distance threshold to be proportional to the speed of the movable platform can further improve the safety of the movable platform.

According to an exemplary embodiment of the present disclosure, the intelligent auxiliary lighting method further includes acquiring an image captured by a camera on a movable platform and turning on the light source when the average brightness of the image is less than a predetermined brightness threshold.

In this exemplary embodiment, the conditions for turning on the light source here and the aforementioned conditions for turning on the light source are not mutually exclusive. That is, the light source can be turned on when any one of the conditions is met so as to maximize the safety of the movable platform at night. However, the present disclosure is not limited to these. It can also be set to enable the light source only when both conditions are satisfied, that is, the shortest distance in the distance information is less than the predetermined distance threshold and the average brightness of the image is less than the predetermined brightness threshold. This saves energy consumption and improves lighting efficiency while ensuring the safety of the movable platform at night.

Optionally, the photographing device may be a depth camera, a visible light camera, an infrared camera, or a thermal imaging camera, etc. When the photographing device is a depth camera, the depth camera and the aforementioned distance measuring device may be the same device or different devices. For example, the depth camera and the distance measuring device are both binocular vision sensors, or the depth camera is a binocular vision sensor, and the distance measuring device is a TOF sensor. It should be noted that those of ordinary skill in the art can make selections according to actual needs, which are not limited to those in the above embodiments.

Optionally, when the image is an 8-bit grayscale image, the grayscale image can present 256 grayscale levels, and the grayscale level corresponding to the expected brightness of the image is between 100-200. At night, when the exposure time and exposure gain are adjusted to the maximum level, the gray level corresponding to the average brightness is around 50. According to this condition, the auxiliary lighting system can be triggered to turn on. That is, when the image is an 8-bit grayscale image, the predetermined brightness threshold is the corresponding brightness value when the grayscale level is 50. However, the present disclosure is not limited to this, and those of ordinary skill in the art can also set other predetermined brightness thresholds according to actual needs.

According to an exemplary embodiment of the present disclosure, the intelligent auxiliary lighting method further includes acquiring an image captured by a camera on a movable platform, and turning on the light source when a target object appears in the image. The target object may include a human face or a human body. For example, it is first determined that whether the target object appears in the image. In one embodiment, the image can be segmented, and then the features of each image area after segmentation are obtained. Then, whether the target object appears in the image is determined based on the features. The features here may include but are not limited to shape features. Optionally, the target object may be a person's limbs or other parts, and the target object may also be a building. In one embodiment of the present disclosure, the light source is turned on when the target object appears in the recognition image. This can save energy consumption and improve the lighting efficiency, and at the same time improve the night shooting quality of the shooting device on the movable platform.

The present auxiliary lighting systems do not flexibly adjust the brightness of the light source, which may cause a waste of power and a decrease in efficiency in some application scenarios. For example, if the object in front is close, a strong light source is not needed. At this time, the light intensity should be reduced. Especially when there are people in front, too high brightness may cause damage to human vision. At the same time, for a longer lighting distance, higher-power LEDs are usually selected. The conduction current of these LEDs is larger (maybe more than 1 ampere), thereby resulting in higher heat generation. However, the working efficiency of the LED is often affected by temperature. If the LED is lit for a long time, the LED may cause heat generation, thereby reducing the efficiency.

Therefore, in order to reduce energy loss, improve lighting efficiency, avoid overexposure, and be more user-friendly, the intelligent auxiliary lighting method of one embodiment of the present disclosure adjusts the brightness of the light source through the light source control device after the auxiliary lighting system is turned on.

According to an exemplary embodiment of the present disclosure, controlling the light source according to the distance information includes controlling the brightness of the light source based on the distance information.

According to an exemplary embodiment of the present disclosure, controlling the brightness of the light source based on the distance information includes controlling the brightness of the light source based on the shortest distance in the distance information.

According to an exemplary embodiment of the present disclosure, controlling the brightness of the light source based on the distance information includes controlling the brightness of the light source based on the distance of the target object in the surrounding environment where the movable platform is located.

According to an exemplary embodiment of the present disclosure, controlling the brightness of the light source based on the distance information includes adjusting the brightness of the light source so that the brightness of the object corresponding to the shortest distance in the image or the brightness of the target object in the image is at a predetermined level. Optionally, the image is an image taken by a photographing device on the movable platform. This not only ensures reliable and effective lighting, but also reduces energy loss and improves lighting efficiency.

Optionally, the photographing device may be a depth camera, a visible light camera, an infrared camera, or a thermal imaging camera, etc. When the photographing device is a depth camera, the depth camera and the above-mentioned distance measuring device can be the same device or different devices. For example, the depth camera and the distance measuring device are both binocular vision sensors. Alternatively, the depth camera is a binocular vision sensor, and the distance measuring device is a TOF sensor. It should be noted that those of ordinary skill in the art can make selections according to actual needs, which are not limited to the above embodiments.

Optionally, when the image is an 8-bit grayscale image, the grayscale image can present 256 grayscale levels, and the grayscale level corresponding to the expected brightness of the image is between 100-200. According to this condition, when the image is an 8-bit grayscale image, the predetermined range is the corresponding brightness value range when the grayscale level is 100-200. However, the present disclosure is not limited to this, and those skilled in the art can also set other ranges according to actual needs.

According to an exemplary embodiment of the present disclosure, the intelligent auxiliary lighting method further includes adjusting the lighting direction of the light source according to the orientation information of the object corresponding to the shortest distance or the orientation information of the target object. That is to say, the posture of the light source is adjustable. Optionally, the lighting direction of the light source can be adjusted according to the orientation of the object corresponding to the shortest distance or the orientation of the target object, so that the lighting direction points to the direction of the object corresponding to the shortest distance or the target object.

For example, in a scene where the UAV is following a person at night, the light source can always point to the direction of the person. Alternatively, in a scene where the UAV is surrounding a point of interest, the direction of the light source is always pointed to the direction of the point of interest, which may be selected by the user through the user interface.

Optionally, the lighting direction of the light source can be adjusted by adjusting the posture of the movable platform or by adjusting the posture of the light source. For example, when the relative pose of the light source and the UAV is immutable, that is, when the light source is fixedly installed on the UAV, the lighting direction of the light source can be adjusted by adjusting the posture of the UAV. When the light source is installed on the UAV through equipment such as a pan/tilt, the posture of the light source can be adjusted by adjusting the posture of the pan/tilt, thereby adjusting the lighting direction of the light source.

Optionally, the number of light sources is multiple, so that the lighting direction of the light source can be adjusted by adjusting the brightness of each of the multiple light sources. For example, the light sources are arranged at equal intervals to form a light source array. When the orientation information of the object corresponding to the shortest distance or the target object is obtained, the brightness of each light source in the light source array can be adjusted to adjust the lighting direction of the light source array.

According to an exemplary embodiment of the present disclosure, controlling the brightness of the light source according to the distance information includes controlling the brightness of the light source by adjusting the conduction current or the duty cycle of the PWM signal based on the shortest distance in the distance information or the distance of the target object in the surrounding environment where the movable platform is located.

According to an exemplary embodiment of the present disclosure, the conduction current is proportional to the second power of the shortest distance or the second power of the distance to the target object. Alternatively, the conduction current is proportional to the polynomial formed by the second power of the shortest distance or the polynomial formed by the second power of the distance to the target object.

A specific method for controlling the brightness of the light source according to one embodiment of the present disclosure will be described in detail below.

Generally, light-emitting devices such as LEDs can adjust the luminous intensity by controlling the conduction current. The luminous intensity of light-emitting devices such as LEDs is generally directly proportional to the forward conduction current. Another method is to use the PWM signal to adjust the duty cycle to control the brightness of the light. The duty cycle is proportional to the brightness.

In one embodiment, after the depth map from the depth camera is obtained, the shortest distance in the depth image is calculated and recorded as do. As shown in FIG. 2, the light intensity decays with the inverse square of the distance. Assuming that the method of adjusting the current is used to control the brightness, in order to compensate for the decay of the light intensity, the current value can be set to increase with the square of the distance, namely:

I₀=Iᵣ+A*d₀²

Among them, A is a proportional coefficient, which is selected according to the actual situation, and Iᵣ is a reference current, that is, the current when d₀=0.

According to an exemplary embodiment of the present disclosure, adjusting the brightness of the light source by adjusting the conduction current include: setting the conduction current to be proportional to the first, third, or fourth power of the shortest distance, or setting the conduction current to be proportional to a polynomial composed of the first, third, and fourth powers of the shortest distance.

According to an exemplary embodiment of the present disclosure, the intelligent auxiliary lighting method further includes obtaining the moving speed of the movable platform and controlling the brightness of the light source based on the moving speed of the movable platform. Optionally, the greater the speed of the movable platform, the greater the brightness of the light source.

Optionally, the brightness of the light source can be controlled based on the distance information of objects in the surrounding environmental where the movable platform is located. Optionally, the light source control device can control the brightness of the light source based on the movement speed of the movable platform. Optionally, the light source control device can control the brightness of the light source based on the distance information of the surrounding environment where the movable platform is located and the movement speed of the movable platform.

Optionally, the movable platform stores the corresponding reference relationship between the distance information of objects in the surrounding environment where the movable platform is located and the brightness of the light source. The light source control device can obtain the distance information of the objects in the surrounding environment where the movable platform is located, and determine the brightness of the light source based on the distance information and the corresponding reference relationship. Optionally, the corresponding reference relationship between the speed of the movable platform and the brightness of the light source is stored in the movable platform. The light source control device can obtain the speed of the movable platform and determine the brightness of the light source based on the speed and the corresponding reference relationship. Optionally, the movable platform stores the corresponding reference relationship between the distance information of objects in the surrounding environment where the movable platform is located and the brightness of the light source and the corresponding reference relationship between the movement speed of the movable platform and the brightness of the light source. The light source control device can obtain the distance information of the objects in the surrounding environment where the movable platform is located and the movement speed of the movable platform, and then determine the brightness of the light source based on the distance information and the movement speed and the corresponding reference relationships.

Since the higher the speed of the movable platform, the longer the braking distance and the greater the risk of collision with obstacles, the brightness of the light source can be set to be proportional to the speed of the movable platform. Alternatively, the brightness of the light source is set to be proportional to the polynomial formed by the shortest distance in the distance information and the speed of the movable platform, which can further improve the safety of the movable platform.

According to an exemplary embodiment of the present disclosure, the light source may be a visible light or infrared light source system.

According to an exemplary embodiment of the present disclosure, the light source includes a light emitting device and a driving circuit, and the light emitting device may be an LED, a laser diode, or a halogen lamp.

According to an exemplary embodiment of the present disclosure, the light source further includes a condenser lens.

According to an exemplary embodiment of the present disclosure, the lighting direction of the light source is the movement direction of the movable platform. The movable platform may be a UAV, an unmanned vehicle, a handheld camera or a robot, but is not limited to these.

It can be seen from the above that the intelligent auxiliary lighting method according to one embodiment of the present disclosure controls the turning on of the light source based on the distance information, thereby improving the safety of the movable platform in the dark environment. At the same time, controlling the brightness of the light source based on the distance information can reduce energy loss, improve lighting efficiency, and avoid overexposure.

FIG. 4 shows a block diagram of a light source control device according to an exemplary embodiment of the present disclosure. The light source control device is disposed on a movable platform. The movable platform includes a light source, and the light source is used to provide lighting. As shown in FIG. 4, the light source control device 400 may include a processor 410 and a memory 420.

The memory 420 may include a volatile memory. The memory 420 may also include a non-volatile memory. The memory 420 may also include a combination of the foregoing types of memories. The processor 410 may be a central processing unit (CPU). The processor 410 may further include a hardware chip. The foregoing hardware chip may be an application-specific integrated circuit (ASIC), a programmable logic device (PLD), or a combination thereof. The above-mentioned PLD may be a complex programmable logic device (CPLD), a field-programmable gate array (FPGA) or any combination thereof.

According to an exemplary embodiment of the present disclosure, the light source control device further includes a data interface 430, which is used to transmit data information.

Optionally, the memory 420 is used to store program code, and the processor 410 calls the program code. When the program code is executed, it is used to perform the following operations: obtaining distance information of objects in the surrounding environment where the movable platform is located; controlling the light source to be turned on based on the distance information and/or controlling the brightness of the light source based on the distance information.

Optionally, when the processor 410 controls the turning on of the light source based on the distance information, it is specifically configured to turn on the light source when the distance information meets a preset condition.

Optionally, the preset condition includes that the shortest distance in the distance information is less than a predetermined distance threshold.

Optionally, the predetermined distance threshold is set based on the speed of the movable platform, and the operation further includes acquiring the speed of the movable platform.

Optionally, the operation further includes acquiring an image captured by a photographing device on the movable platform and turning on the light source when the average brightness of the image is less than a predetermined brightness threshold.

Optionally, the operation further includes acquiring an image taken by a photographing device on the movable platform and turning on the light source when a target object appears in the image.

Optionally, the target object includes a human face or a human body.

Optionally, when the processor 410 controls the brightness of the light source based on the distance information, it is specifically configured to control the brightness of the light source based on the shortest distance in the distance information.

Optionally, when the processor 410 controls the brightness of the light source based on the distance information, it is specifically configured to control the brightness of the light source based on the distance of the target object in the surrounding environment where the movable platform is located.

Optionally, when the processor 410 controls the brightness of the light source based on the distance information, it is specifically configured to adjust the brightness of the light source to make the brightness of the object corresponding to the shortest distance in the image or the brightness of the target object in the image is within a predetermined range. The image may be an image taken by a photographing device on the movable platform.

Optionally, the operation further includes adjusting the lighting direction of the light source based on the orientation information of the object corresponding to the shortest distance or the orientation information of the target object.

Optionally, when the processor 410 adjusts the lighting direction of the light source, it is specifically configured to adjust the lighting direction of the light source by adjusting the posture of the movable platform or by adjusting the posture of the light source.

Optionally, the number of the light sources is multiple. When the processor adjusts the lighting direction of the light source, it is specifically configured to adjust the lighting direction of the light source by adjusting the brightness of each light source of the multiple light sources.

Optionally, when the processor 410 controls the brightness of the light source based on the distance information, it is specifically configured to adjust the conduction current or the duty cycle of the PWM signal to control the brightness of the light source based on the shortest distance in the distance information or the distance of the target object in the surrounding environment where the movable platform is located.

Optionally, the conduction current is proportional to the second power of the shortest distance or the second power of the distance of the target object. Alternatively, the conduction current is proportional to the polynomial formed by the second power of the shortest distance, or proportional to the polynomial formed by the second power of the distance of the target object.

Optionally, the operation further includes obtaining the moving speed of the movable platform; and controlling the brightness of the light source based on the moving speed of the movable platform.

Optionally, the distance measuring device is a binocular vision sensor, a TOF sensor, a laser radar, a millimeter wave radar, an ultrasonic sensor, or an infrared sensor.

Optionally, the lighting direction of the light source is the movement direction of the movable platform, and the movable platform is a UAV, an unmanned vehicle, a handheld camera or a robot.

The light source control device provided by one embodiment of the present disclosure controls the light source by using the distance information obtained by the distance measuring device, thereby reducing energy loss, improving lighting efficiency, avoiding overexposure, and improving the safety of the movable platform in the dark environment.

FIG. 5 shows a block diagram of a movable platform according to an exemplary embodiment of the present disclosure. As shown in FIG. 5, the movable platform 500 includes any of the aforementioned intelligent auxiliary lighting systems 100.

The movable platforms provided by embodiments of the present disclosure include, but are not limited to, UAVs, unmanned vehicles, handheld camera devices, and robots.

Through the above detailed description, those of ordinary skill in the art can easily understand that the intelligent auxiliary lighting method, device, system and movable platform according to some embodiments of the present disclosure have one or more of the following advantages:

According to some exemplary embodiments of the present disclosure, the safety of the movable platform in the dark environment is improved by combining the distance measuring device and the auxiliary lighting system.

According to some exemplary embodiments of the present disclosure, by using the distance information obtained by the distance measuring device to control the light source, energy loss can be reduced, lighting efficiency can be improved, and overexposure can be avoided.

Those skilled in the art will easily think of other embodiments of the present disclosure after considering the description and practicing the disclosure disclosed herein. The present disclosure is intended to cover any variations, uses or adaptive changes of the present disclosure. These variations, uses or adaptive changes follow the general principles of the present disclosure and include common knowledge or conventional technical means in the technical field not disclosed by the present disclosure. The description and the embodiments are only to be regarded as exemplary, and the true scope and spirit of the present disclosure are pointed out by the following claims.

The principles and the embodiments of the present disclosure are set forth in the specification. The description of the embodiments of the present disclosure is only used to help understand the apparatus and method of the present disclosure and the core idea thereof. Meanwhile, for a person of ordinary skill in the art, the disclosure relates to the scope of the disclosure, and the technical scheme is not limited to the specific combination of the technical features, but also covers other technical schemes which are formed by combining the technical features or the equivalent features of the technical features without departing from the inventive concept. For example, a technical scheme may be obtained by replacing the features described above as disclosed in this disclosure (but not limited to) with similar features.

What is claimed is:

1. An intelligent auxiliary lighting system for a movable platform, comprising:
a distance measuring device for obtaining distance information of objects in a surrounding environment where the movable platform is located; and
an auxiliary lighting system comprising a light source and a light source control device,
wherein the light source control device is configured to control turning on the light source based on the distance information and/or control brightness of the light source based on the distance information.

2. The intelligent auxiliary lighting system of claim 1, wherein the controlling turning on the light source based on the distance information comprises turning on the light source when the distance information meets a preset condition.

3. The intelligent auxiliary lighting system of claim 2, wherein the preset condition comprises that the shortest distance in the distance information or a distance of a target object in the surrounding environment where the movable platform is located is less than a predetermined distance threshold.

4. The intelligent auxiliary lighting system of claim 3, wherein the light source control device is further configured to acquire a speed of the movable platform, and the predetermined distance threshold is set based on the speed of the movable platform.

5. The intelligent auxiliary lighting system of claim 1, further comprising a photographing device on the movable platform,
wherein the light source control device is further configured to acquire an image taken by the photographing device on the movable platform and turn on the light source when an average brightness of the image is less than a predetermined brightness threshold.

6. The intelligent auxiliary lighting system of claim 1, further comprising a photographing device on the movable platform,
wherein the light source control device is further configured to acquire an image taken by the photographing device on the movable platform and turn on the light source when a target object appears in the image.

7. The intelligent auxiliary lighting system of claim 6, wherein the target object comprises a human face or a human body.

8. The intelligent auxiliary lighting system of claim 1, wherein the controlling the brightness of the light source based on the distance information comprises controlling the brightness of the light source based on the shortest distance in the distance information.

9. The intelligent auxiliary lighting system of claim 1, wherein the controlling the brightness of the light source based on the distance information comprises controlling the brightness of the light source based on a distance of a target object in the surrounding environment where the movable platform is located.

10. The intelligent auxiliary lighting system of claim 1, further comprising a photographing device on the movable platform,
wherein the controlling the brightness of the light source based on the distance information comprises capturing an image by the photographing device on the movable platform, and adjusting the brightness of the light source so that brightness of an object corresponding to the shortest distance in the image or brightness of a target object in the image is within a predetermined range.

11. The intelligent auxiliary lighting system of claim 10, wherein the light source control device is further configured to adjust lighting direction of the light source based on orientation information of the object corresponding to the shortest distance or orientation information of the target object.

12. The intelligent auxiliary lighting system of claim 11, wherein the adjusting the lighting direction of the light source comprises adjusting posture of the movable platform and/or adjusting posture of the light source.

13. The intelligent auxiliary lighting system of claim 11, wherein the lighting direction of the light source is a movement direction of the movable platform, and the movable platform comprises an unmanned aerial vehicle, an unmanned vehicle, a handheld camera or a robot.

14. The intelligent auxiliary lighting system of claim 11, wherein the auxiliary lighting system comprises a plurality of light sources, and the adjusting the lighting direction of the light source comprises adjusting brightness of each of the plurality of light sources.

15. The intelligent auxiliary lighting system of claim 1, wherein the controlling the brightness of the light source based on the distance information comprises adjusting a conduction current or a duty cycle of a PWM signal of the light source based on the shortest distance in the distance information or a distance of a target object in a surrounding environment where the movable platform is located.

16. The intelligent auxiliary lighting system of claim 15, wherein the conduction current is configured to be proportional to a second power of the shortest distance or a second power of the distance of the target object or the conduction current is configured to be proportional to a polynomial formed by the second power of the shortest distance or a polynomial formed by the second power of the distance of the target object.

17. The intelligent auxiliary lighting system of claim 1, wherein the light source control device is further configured to acquire a moving speed of the movable platform and control the brightness of the light source based on the moving speed of the movable platform.

18. The intelligent auxiliary lighting system of claim 1, wherein the distance measuring device comprises a binocular vision sensor, a TOF sensor, a lidar, a millimeter wave radar, an ultrasonic sensor or an infrared sensor.

19. A movable platform, comprising the intelligent auxiliary lighting system of claim 1.

20. An intelligent auxiliary lighting method for a movable platform, the movable platform comprising a distance measuring device, a light source, and a light source control device, the method comprising:
acquiring distance information of objects in a surrounding environment where the movable platform is located by the distance measuring device; and
controlling turning on the light source based on the distance information and/or controlling brightness of the light source based on the distance information by the light source control device.
